(19) United States
(12) Patent Application Publication
(10) Pub. No.: US 2002/0087560 A1
(43) Pub. Date: Jul. 4, 2002

(54) On-line class and curriculum management

(76) Inventor: Greg Bardwell, Rockville, MD (US)

Correspondence Address: Michael de AngeLI, 60 INTREPID LANE, JAMESTOWN,, RI, 02835, US

(21) Appl. No.: 09/750,123

(22) Filed: Dec. 29, 2000

(51) Int. Cl. G06F 7/00

(52) U.S. Cl. 707/100

(57) ABSTRACT

A system for enabling educators to develop syllabi of assignments, including tests, for online education comprises a software platform, provided in different versions for educators in defining syllabi and students in accessing the syllabi and completing the assignments, and a database containg the syllabi, assignments to be employed increating syllabi, questions to be employed in creating assignments, and lists of educators, students, and classes.

### FIELD OF THE INVENTION

This invention relates to the use of computers and the Internet to provide convenient and flexible learning tools for students and educators.

### BACKGROUND OF THE INVENTION

There have been numerous proposals for products intended to employ the increasing popularity and wide availability of personal computers and the Internet to ease the labor of educators. For example, course management and assignment tracking software is available from BoxerMath.com as “Ledger” and from LearningGate.com as “eGrader”. These programs are discussed in further detail below, and do not appear to provide assistance to teachers, particularly in connection with preparing working materials for Internet delivery.

More specifically, it has not escaped the attention of the art that educators typically spend a great deal of time in repetitive tasks, such as preparation of teaching materials and grading of assignments and tests, which could desirably be automated. For example, primary teaching tools commonly include printed or photocopied materials setting problems to be solved, such as homework assignments, problem sets, tests and exams, and workbooks, all of which typically include the same problems to be solved by classes of many students, and which then, if in written form, must be manually corrected. The art has recognized that both the preparation of the materials and the correction process can desirably be automated.

More particularly, the art recognizes that educators can prepare and distribute such teaching materials by computer, and that the results, that is, the students' answers, can then be automatically graded. For example, it is known to employ what amounts to a word-processing program to select problems from a database, thus creating, for example, a worksheet, and then to distribute it by computer, e.g., by making it accessible to students over the Internet. The students can then enter their answers in predetermined spaces, and their grades automatically calculated and recorded. Products of this general type are available from Blackboard.com and Quia.com, and are discussed in further detail below.

More recently, there have appeared products allowing one-on-one tutoring over the Internet, that is, wherein both a single student and a single teacher are provided with microphones, headphones, and audio-processing circuitry and software, so as to be able to communicate verbally over the Internet, and also with respective “whiteboards”, so that both can use a mouse or the like to write on a common tablet, in effect, and see the results of one another's work. See the discussion of “ESylvan” in “New Sylvan Subsidiary Offers Online Tutoring”, Washington Post, Oct. 16, 2000.

As will appear below, none of these products satisfy the objects of the present invention.

### OBJECTS AND SUMMARY OF THE INVENTION

The overall object of the invention is to provide an integrated set of tools and programs that function together with a database in order to enable educators to readily prepare and electronically distribute “syllabi” for any number of students, and to enable the students to access and use the syllabi. A “syllabus” according to the invention typically comprises a set of assignments or tests, each comprising a series of questions to be answered or activities to be performed online, and is that data structure which the students access in order to launch online learning activities. The system of the invention provides automatic tracking and grading of the students' interaction with each of the assignments of the syllabus. As will apppear below, the syllabus editing system provided according to the invention is an important aspect of the overall learning system provided thereby. More specific objects of the invention will appear from the discussion below.

It should be clearly understood that although the invention is described in connection with an implementation for teaching of mathematics at the secondary school level, the invention is not so limited. The invention is relatively directly adaptable to the teaching of other objective subjects, such as science, history, or language arts, and various of the tools provided according to the invention for preparing and distributing syllabi and for automated grading of student work, and other features and capabilities provided according to the invention, may be used in the teaching of various other subjects. Accordingly, the invention should not be considered to be limited to the teaching of any one subject.

The learning system of the invention is referred to herein as MathRealm, for convenience. Summarizing the invention, MathRealm is a Class and Curriculum Management Platform comprising a number of tools that interact with a database maintained by the proprietor of the platform to provide a teaching tool for educators and students. Using the tools provided by the MathRealm platform, and interacting with the database, instructors can create online syllabi that link directly to lessons and activities, develop tests and worksheets, and track the performance of individual students. Students can access stored syllabi and work at their own pace, or students and educators can interact in real time using the Whiteboard provided according to an important aspect of the invention, and discussed in detail below. An instructor can create a class, add students to the roster, and create a syllabus for the class using proprietary assignments, Custom Types such as tests developed by the instructor using proprietary tools, off-line assignments, or any other nonproprietary Web resources.

MathRealm includes novel tools for creating content that can be included in a syllabus. For example, the MathRealm Worksheet & Test Studio is a tool for creating and delivering online tests and worksheets, and the MathRealm Lesson Tool allows a user to create a custom slide show lesson to include in syllabi.

MathRealm's Whiteboard is a collaborative workspace where numerous users can interact so as to work collectively on common problems. Numerous students and a teacher, for example, can simultaneously input text and drawings, and can discuss one another's contributions. This is especially useful for teaching of concepts in fractions, percents, tables, graphs, and plots. The Whiteboard is designed for sharing ideas and working on problems with others over the Web, and has unique tools and methods for collaboratively sharing work.

### BRIEF DESCRIPTION OF THE DRAWINGS

The invention will be better understood if reference is made to the accompanying drawings, in which:

FIG. 1 is a “screen shot”, that is, a reproduction of the display on a computer screen, in this case showing a view of the screen of the teacher's computer, illustrating “platform menu tabs” provided according to the invention, and thus illustrating this aspect of the user interface of the system of the invention;

FIG. 2 is a similar view showing the “syllabus wizard”;

FIG. 3 is a similar view showing the “new syllabus edit” screen;

FIG. 4 is a similar view showing the “edit syllabus unit” screen;

FIG. 5 is a similar view showing an exemplary MathRealm syllabus;

FIG. 6 is a diagram illustrating the principal components of the syllabus data structure, and the relationship between them;

FIG. 7 shows a detail of one of these components, the assignment table;

FIG. 8, which comprises a first sheet labeled FIG. 8 and three additional sheets showing enlarged views of FIGS. 8A, 8C, 8D, 8E, 8F, and 8H, provided in smaller views on

FIG. 8, illustrates the operation of the Test Studio provided according to this aspect of the invention;

FIG. 9 shows a typical screen encountered when selecting a subject to populate the online assignment resource menu, which includes proprietary assignments and custom tests;

FIG. 10 shows a typical screen employed to select proprietary assignments or a custom-designed test;

FIG. 11 shows a screen provided to allow editing of Web page URL addresses;

FIG. 12 illustrates a typical assignment screen encountered in connection with scoring of students' work;

FIG. 13 shows a typical screen provided as part of a custom test;

FIG. 14 shows a typical screen provided for custom test scoring;

FIG. 15 shows a typical screen provided for external Web page scoring;

FIGS. 16-20 are views of screens provided by various prior art interactive educational programs;

FIG. 21 shows an example of the whiteboard provided according to the invention;

FIG. 22 illustrates a screen provided to the teacher in an online whiteboard session, for allowing selection of the student(s) work to view and respond to;

FIG. 23 illustrates a fading tool provided to allow comprehensible overlays of the teacher's and student's work on the same screen;

FIG. 24 illustrates the discussion area provided on the whiteboard according to the invention;

FIGS. 25 and 26 illustrate the whiteboard provided according to prior art programs; and

FIG. 27, which is provided on two sheets, illustrates the organization of and relationships between various tables making up the database for interaction with the platform provided according to the invention.

### DESCRIPTION OF THE PREFERRED EMBODIMENTS

The following describes the MathRealm Class and Curriculum Management Platform and the proprietary tools provided according to the invention in detail, and describes their interaction with a database maintained by the proprietor of the platform, referred to herein as the proprietor's database. As noted above, the invention is described in connection with an implementation optimized for teaching of high-school mathematics, but is not to be thus limited.

Overview: Class & Curriculum Management Platform

The MathRealm Class & Curriculum Management platform according to the invention provides a unique combination of useful features that are integrated so as to provide maximal use of the varied features. The invention is implemented employing a suite of resources and programs accessible to both educators and students through the Internet (or “Web”), which interact in turn with the proprietor's database to implement the functions. MathRealm is the only platform known to the inventor that allows total customization of an online syllabus with online curriculum linking, management and tracking features. MathRealm is also unique in that it includes integrated tools allowing a user to develop, all on the Web, custom resources such as tests or worksheets that are also delivered online. Some of the principal unique features of MathRealm, which are discussed in more detail below, are as follows:

1. Novel database-driven customization of syllabi.

2. Syllabi are customizable at the assignment and unit level for a class or individual students.

3. Users can use a wizard to generate a class syllabus from pre-defined templates.

4. The syllabi link to and launch online content directly.

5. The MathRealm platform includes a proprietary database table of assignments (lessons, tools, tests, practice, learning games, etc.) and external web pages that are used in building customized syllabi. These assignments and web pages are accessed by the syllabus editing tools.

6. Custom tests and worksheets developed by a user are automatically included in the Class and Curriculum Management Platform resources, and can also be included in custom syllabi.

7. Presentations created with platform tools as an assignment are automatically integrated.

8. The platform provides the ability for an instructor to include any external web resource by inserting its URL in a syllabus. User can launch the URL directly from the syllabus as an assignment in the syllabus.

9. The MathRealm system can track student usage of any kind of online resource and generate reports.

Platform Operation

MathRealm's Class and Curriculum Management Platform according to the invention is a unique Web-based tool for building and managing classes and online curriculum. This tool allows a user to create a class with a custom syllabus and manage student access to a class syllabus. The platform also allows reporting on student progress with the syllabus. The platform generates a personalized syllabus for each student entered.

As is generally conventional in the art, the platform is effectively defined by an “application program”, or simply “application”, provided to teacher and students. The application program running on the teacher's computer thus allows the teacher to generate, process, and display syllabi, and a subpart of the same application program or a corresponding student version allows the students similarly to access and interact with the syllabi.

The application program supporting the platform according to the invention described herein is intended to function with a database of stored syllabi, stored problem sets, stored Web addresses, and other materials that can be repetitively used, along with class maintenance information such as students' grade records, class lists and the like. The database is maintained by the “proprietor” of the particular implementation of the platform, and access to the database is controlled through passwords issued to purchasers or licensees of the platform. Preferably, access to the database by the application program supporting the platform is essentially transparent to the user.

The following discusses various steps to be taken and options provided to the educator and student at various points in the creation, distribution, use, and review (among other possible actions) of syllabi as performed in use of the learning system of the invention. Essentially all of the these actions are carried out “on-line”; for example, when an educator “clicks” a button, he or she is causing a message to be sent to the proprietor's Web server, which responds by accessing the proprietor's database and sending the appropriate responsive screen. In general these steps are implemented using the hypertext markup language (“HTML”) as commonly used to implement interactive Internet communication. Those of skill in the art will understand and be capable of practicing the invention disclosed using known programming techniques and tools given the disclosure herein.

The syllabus editing system provided according to the invention may be considered to be the backbone of the platform. A “syllabus” according to the invention is a data structure created by the teacher, typically including a list of assignments, which in turn comprise sets of problems, links to Web pages for reading and other activities, and the like. After creation of a class, that is, a list of student(s) intended to use that syllabus, the syllabus is stored on the database. The corresponding students then access their assigned syllabi from the database and carry out the assigned tasks online, thus performing the learning activities. The student's accessing of the database is monitored and used to track his or her progress in completing lessons, tests, activities, etc. of an assigned syllabus, and suitable reprots are generated. Accordingly, using the system of the invention, educators can thus develop and distribute an individualized (or customized) syllabus for a class or single student, the students can access it individually, and the system automatically tracks the students' usage and grades their responses where appropriate.

In the following, the functionality provided by the platform to the user is described in terms of the user interface, that is, the principal functions provided by the platform according to the invention are first described, in order to emphasize the unique pedagogic advantages of the system of the invention.

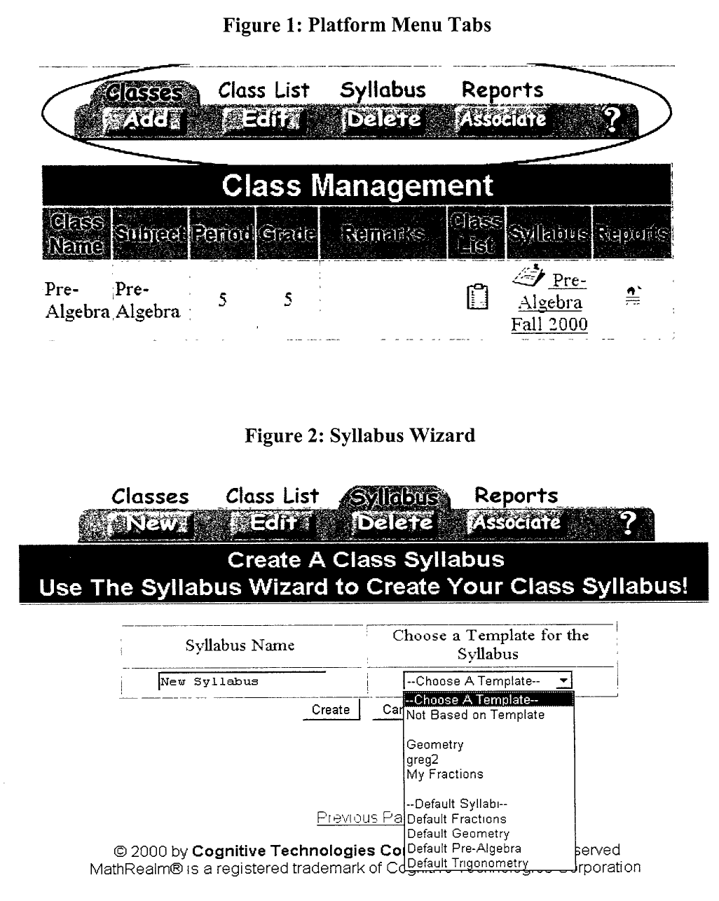

FIG. 1 shows a “screen shot” (that is, a print-out showing all or part of the contents of a computer screen driven by the program under discussion), in this case displaying the Platform Menu Tabs, which form the platform's main tool bar. As will be apparent, this tool bar allows educators to work with Classes, Class Lists, Syllabi and Reports using simple tabbed navigation. Data for one class is shown, and the fact that the platform provides the educator the options to Add new classes, Edit a class, Delete a class, or change the Association of a class with a different syllabus will be apparent.

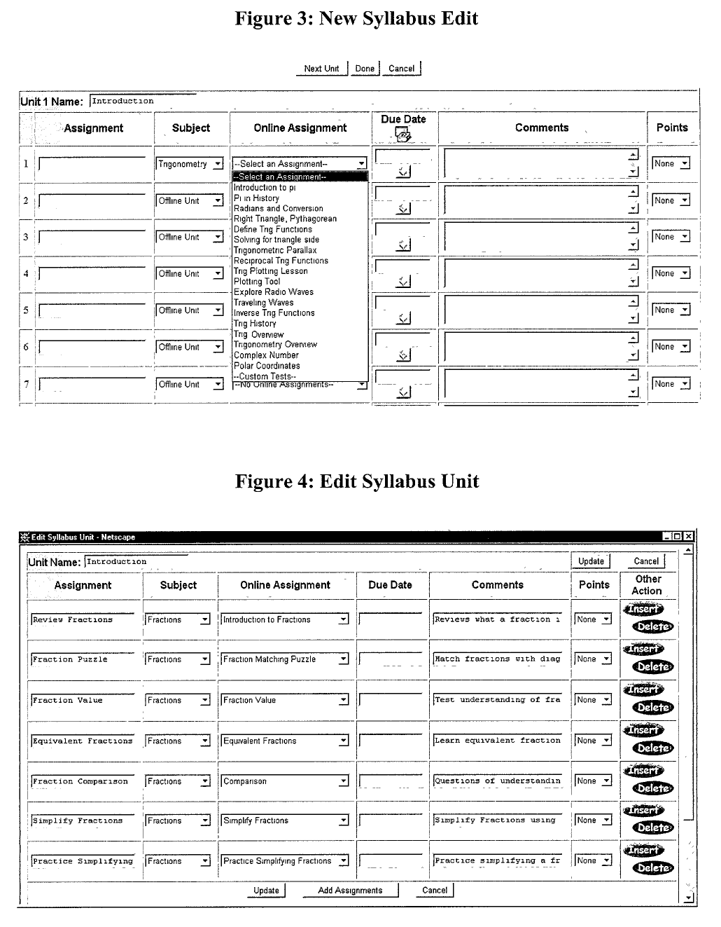

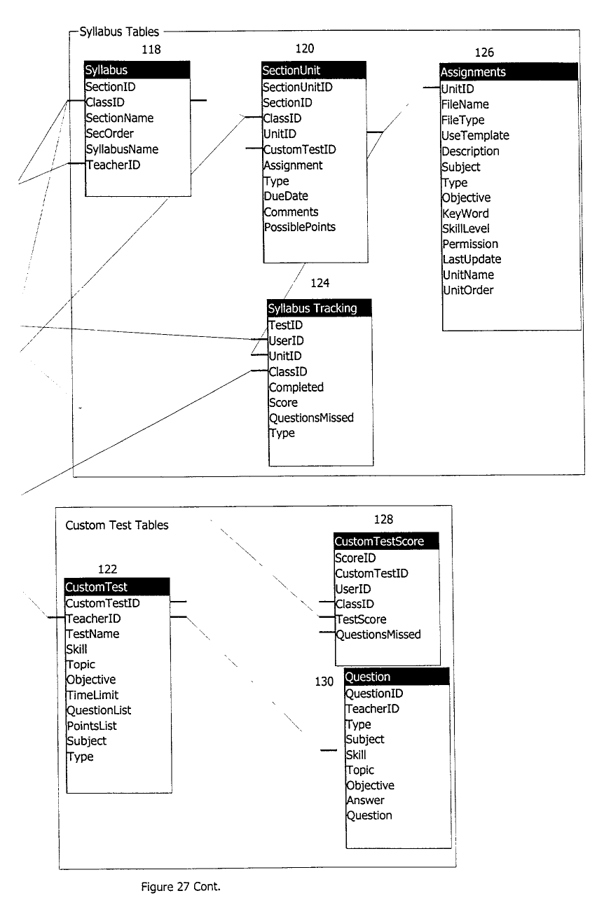

In order to create a new syllabus, the educator clicks the New button under the Syllabus tab. See FIG. 2. As illustrated, the educator is provided the option to create a customized syllabus not conforming to a predefined format by selecting “Not Based on Template” in the drop-down menu of “Choose a Template for the Syllabus.” There is also the option to select one of the default syllabi under the “--Default Syllabi--” heading. The Default Syllabi save time and effort by copying a pre-built syllabus from the proprietor's database for a subject. An educator can also use this drop-down menu to duplicate and edit a previously created syllabus. This allows the easy individualization of a syllabus for a specific student or class. For example, in order to help a a student having particular difficulty with a particular class of problems the teacher might add a sequence of problems, from easy to hard, but all solved using the same basic concept, to a preexisting syllabus. Additional problems can be generated by the teacher and added to the syllabus, or selected from problems stored in the proprietor's database. (The structure of the database is shown in FIG. 27 and discussed in detail below.)

Every syllabus created by an educator is a resource specific to that user (“User”, in this application, is inclusive of both students and educators, which can include teachers per se, parents, and others) and appears in the drop-down menu. A name for the new syllabus must be entered in the “Syllabus Name” HTML form field. When the educator is finished entering the required data, he or she clicks the Create button to create the syllabus. If a Default Syllabus or another one of the educator's syllabi is selected, then that syllabus is duplicated and stored in the database for that educator and can be assigned to a specific student or class, and made available for editing by the educator.

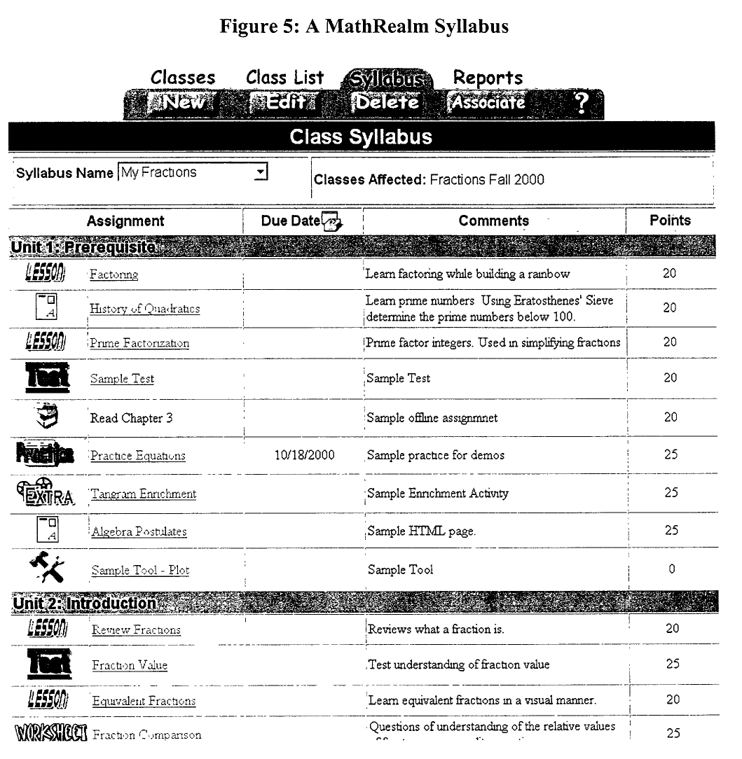

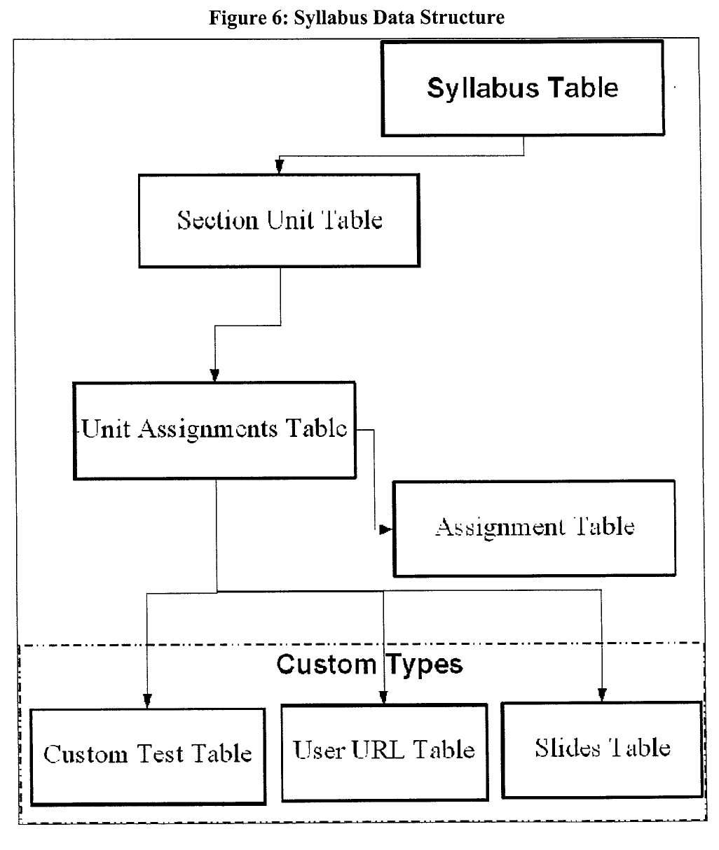

If the educator indicates a need to create a new syllabus not based on a template, the appropriate menu selections lead to the screens in FIGS. 3 and 4 for creation and editing of the new syllabus, respectively.

In the preferred implementation, syllabi are organized as sequences of units, and each unit is a sequence of assignments, organized in the following manner:

Unit 1: Unit name

Assignment 1

Assignment 2 . . .

Unit 2: Unit name

Assignment 1

Assignment 2 . . .

The user names both units and assignments by filling in HTML form fields, as illustrated in FIGS. 3 and 4. The Subject drop-down menus are used at the assignment level to populate the Online Assignment drop-down menu as needed. For example, if the subject selected is Fractions, all the relevant assignments of any type (lessons, tools, tests, activities, games, etc.) in the proprietor's assignment database (see below) appear in the Online Assignment drop-down menu for selection by the educator. Also, any Custom Types (see below), such as user-defined web pages (that is, the educator can enter a universal resource locator (“URL”) for the student to access for further information or lesson material), tests, worksheets, or custom lesson slide shows, created by the user and pertaining to the selected subject are included in the Online Assignment drop-down menu under their own heading.

All assignments are named by the teacher or other editor who produces them. Comments can be added, and due dates and possible point values can be assigned. An Offline Unit assignment, such as “Read Chapter 2 of Your Textbook”, can be included by selecting the Offline Unit in the Subject drop-down menu, which is the default setting (see FIG. 3 or 4). The comment field allows detailed instructions or comments.

MathRealm also provides tools to educators to create Custom Types to include in their own syllabi. Custom Types include tests, worksheets or custom lesson slide shows developed by the educator. When a Custom Type resource is created by a user he or she names the resource and gives it a subject heading. This name is then put in the drop-down menu, forming another possible choice. Custom Types are discussed in further detail below.

The user can also select Web Page from the Subject menu (FIG. 4) and is presented with a window to enter a valid web URL for an assignment. This web page is then included in the syllabus for students to use.

The syllabus editor can add as many or as few assignments to a syllabus unit as needed. By pressing a More Assignments button (not shown) the ability to add ten more assignments to the current unit is provided; similarly, in order to add another syllabus unit, the user presses the Next Unit button (see FIG. 3). Repeatedly adding units and assignments to units allows the user to develop a complete syllabus.

After a syllabus has been created, all aspects of the syllabus can still be edited by pressing the Edit button on the tool bar (FIG. 1) when the syllabus is displayed. The option to edit any unit is then given. One can insert, delete, or edit units. FIG. 4 is the window that pops up to edit an existing syllabus unit. A user can completely edit every field of every assignment, insert assignments, add assignments at the end, and/or delete assignments.

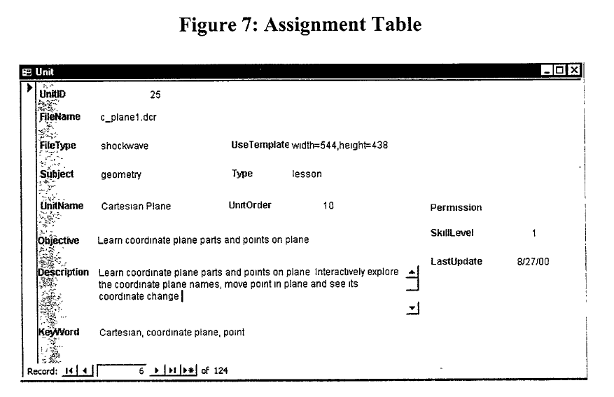

FIG. 5 shows an exemplary partial syllabus, including one whole unit of the syllabus and part of a second unit. As shown, the syllabus includes lessons, tests, worksheets, practice, web pages, tools and enrichment activities, all displayed with icons. That is, the educator can build this syllabus by selecting these items from the proprietor's database of such items, or can add his or her own. The FIG. 5 syllabus is also exactly what a student would see, minus the tool bar. Each assignment is launched into its own window when it is clicked.

Platform Function

The platform according to the invention is database driven with an HTML interface. As noted, the database structure is discussed below in connection with FIG. 27. Pages are dynamically generated using industry standard technologies (ColdFusion, HTML and JavaScript) based upon the functional attributes of each, as summarized above. Customization functions are done through HTML Form pages.

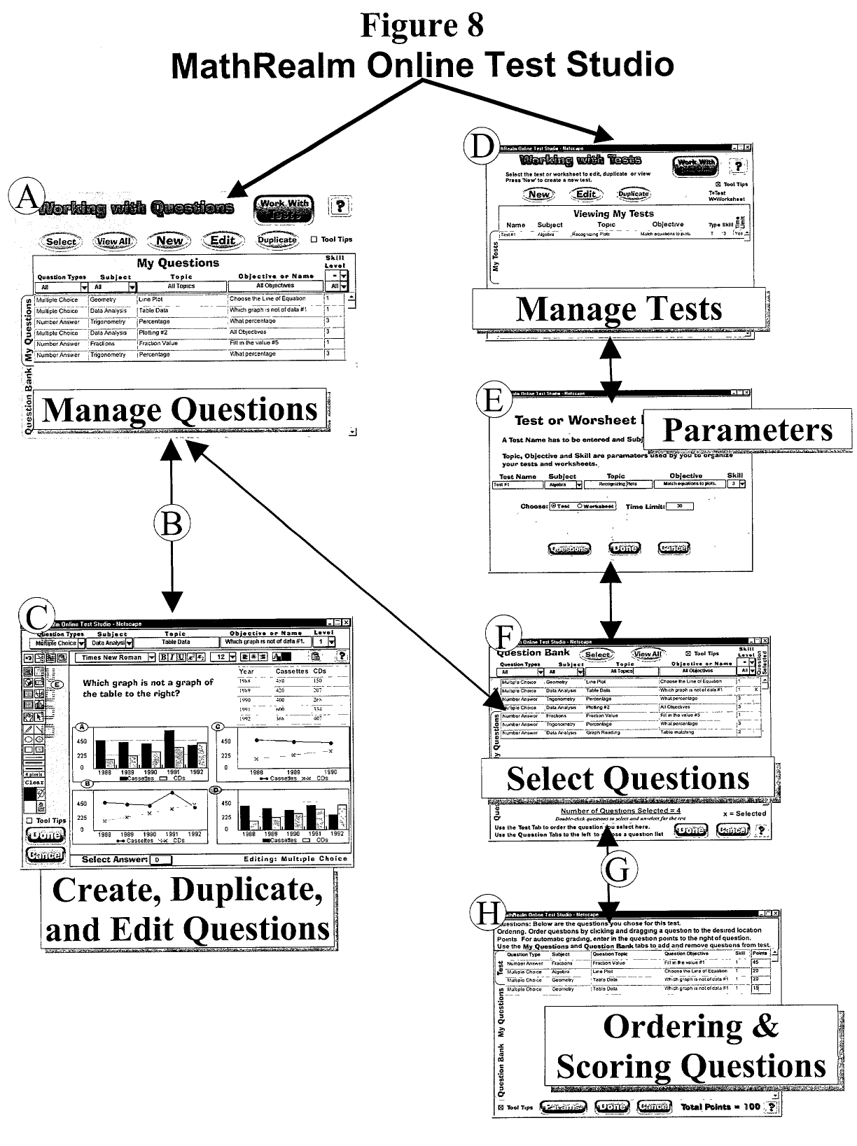

As many of MathRealm's novel features relate to the custom syllabi of the Class and Curriculum Platform, its function is described next. See FIG. 6 for a flow chart illustrating the syllabus data structure. The custom syllabus database is a series of tables starting with the Syllabus Table. The Syllabus Table contains the syllabi, organized by their assigned names and the creator's ID number. Each syllabus is also assigned a unique ID number. The Section Unit Table contains the syllabi units (the units are lists of assignments organized into sections for each syllabus) and a syllabus ID field. The Unit Assignments Table is the main table of all syllabi. It lists each assignment's parameters and links to the Section Unit Table.

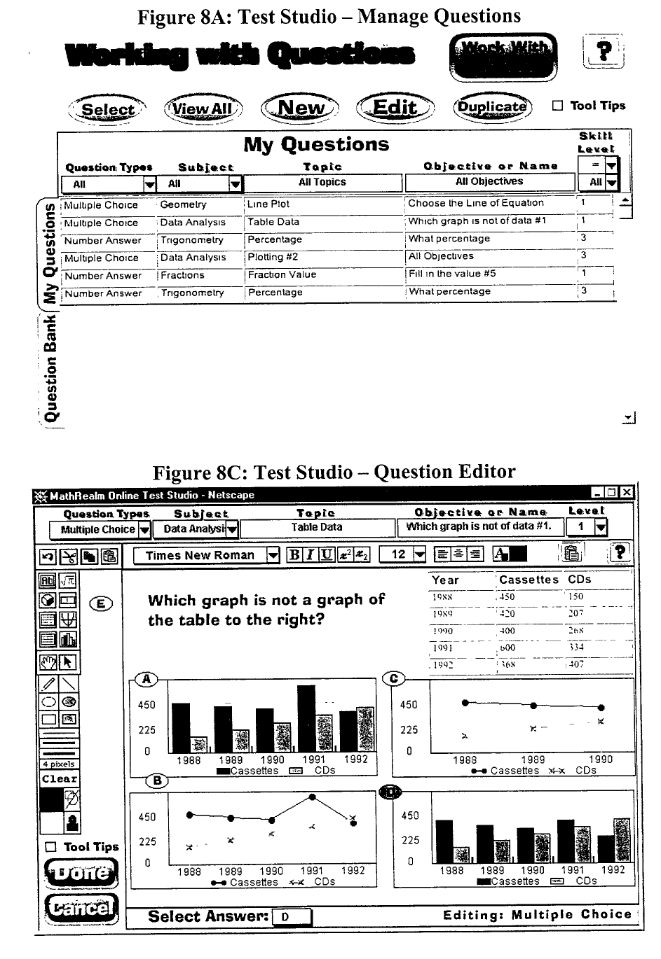

At any time, the Unit Assignments Table is a table of pointers to assignments in the Assignment Table or to Custom Type resources. Each assignment in the Assignment Table contains all the information pertaining to one of the resources (lessons, tools, games, etc.) stored in the proprietor's database, and template information on how to launch the resource. FIG. 7 provides an example of an assignment in the Assignment Table. The Assignment Table also contains entries for Custom Types, when appropriate. When the Unit Assignments Table points to a Custom Type entry it also points to the assignment corresponding entry in the appropriate Custom Type table, examples of which are listed on FIG. 6. The functions that process this are all done by MathRealm's ColdFusion applications when required.

Custom Types are user-defined or user-built resources. For example, MathRealm provides tools for users to build custom tests and slide shows which can be delivered in a syllabus. Also, when a user is editing a syllabus he or she has the opportunity to include any Web resource by including a Web page's URL address. These addresses are stored in the User URL table; the Unit Assignment Table will point to the appropriate entry of this table when the Assignment Table indicates that the entry is a Custom URL entry.

The Assignment Table

The Assignment Table (see FIG. 7) is organized so that users can search for assignments based on subject, assignment type (lesson, tool, practice, games/puzzles, custom tests or worksheets, history, etc.), skill level, or key word. The file name is the resource identifier of the assignment, that is, the file name appears in the assignment menu when editing a syllabus. The file type field tells the system which template to use in launching the file in a window. Each file type has a different template. In the example provided by FIG. 7, the file type is a so-called “Shockwave” file, that is, the stored resource in this case is prepared and stored according to the “Shockwave” format known to the art. [The Shockwave browser plug-in that is necessary for a teacher or student to open and process this type of file typically comes pre-installed on new computers, or can easily be downloaded and installed from www.macromedia.com (Macromedia Inc.'s web site).] Other formats known to the art may similarly be accommodated, giving the syllabus designer the maximum flexibility in choosing items to add to the syllabi.

Stated differently, this template-based system is the primary mechanism used according to the invention in order to allow any type of Internet-based resource, including types not available at initial installation of a particular version of the MathRealm platform, to be added to the platform's capabilities. Thus, assignments and other resources of various types can be added to a syllabus for convenient access by both educator and student.

To add a new type of resource, the system developer can simply add a new file type and a new template for that type. This capability allows any file type supported by the user's browser (e.g., Microsoft Internet Explorer, which most computers have installed at manufacture) to be used as an assignment. For example, to add a file conforming to the Java Applet (a common Web type) file type, the user simply fills the FileType field with “Java” and the FileName field with the Java Applet's file name. All Java Applets would then be stored in a predefined location on the proprietor's web server. The syllabus application would then use the predefined Java Applet templet and the FileName to generate a web page for the resource when included in a syllabus. As with all assignments, this resource would open in a browser window.

When the Unit Assignments Table (FIG. 6) points to assignments in the Assignment Table (FIG. 7) that are reserved for Custom Types, this tells the application processing and displaying the syllabus, i.e., the application program running on the ColdFusion application web server, with the interface hosted in an educator's web browser, providing the platform according to the invention, to look for the Assignment in a specific Custom Type table for the corresponding template defining the resource type. For example, a Assignment Table unit ID of zero (0) might tell the application to look in the Custom Test Table. The Unit Assignments Table then tells the application which custom test to point to; in the example, a unit ID equal to zero in the Assignment Table identifies the HTML template to use to launch the custom test when needed.

Custom Types—Overview

An important advantage provided by the invention is the ability to include Custom Types as assignments in syllabi. Custom Types include user created worksheets and tests (which may be created using tools provided by the platform according to the invention, as further described below), user entered web pages, specified by URL, and custom slide shows. Custom Types are included by a template in the Syllabus Database in the Assignment Table. Custom Types are defined by each instructor user.

Custom Type: Worksheets and Tests

An important aspect of the invention is the Online Worksheet & Test Studio provided thereby, which allows users to create worksheets and tests with a wide variety of questions that can include tables, graphs, plots, drawings, and text. All questions and tests created in the Test Studio are stored on the proprietor's servers as part of the database, and are available for the creator, by password, at any Internet connected computer or workstation, and are similarly available to the students to whom they are assigned, i.e., as part of a class syllabus.

Key features of the Online Worksheet & Test Studio include the following:

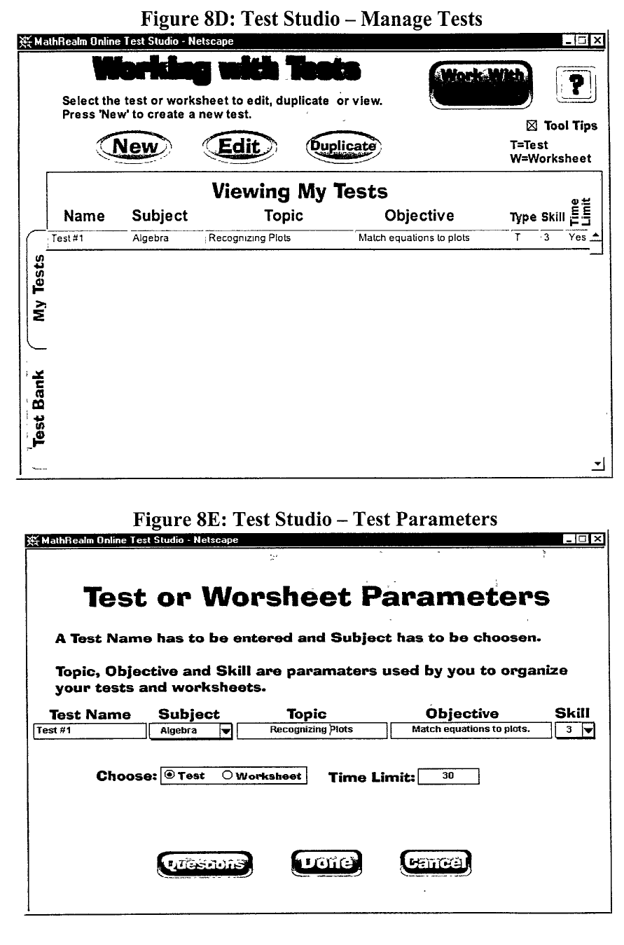

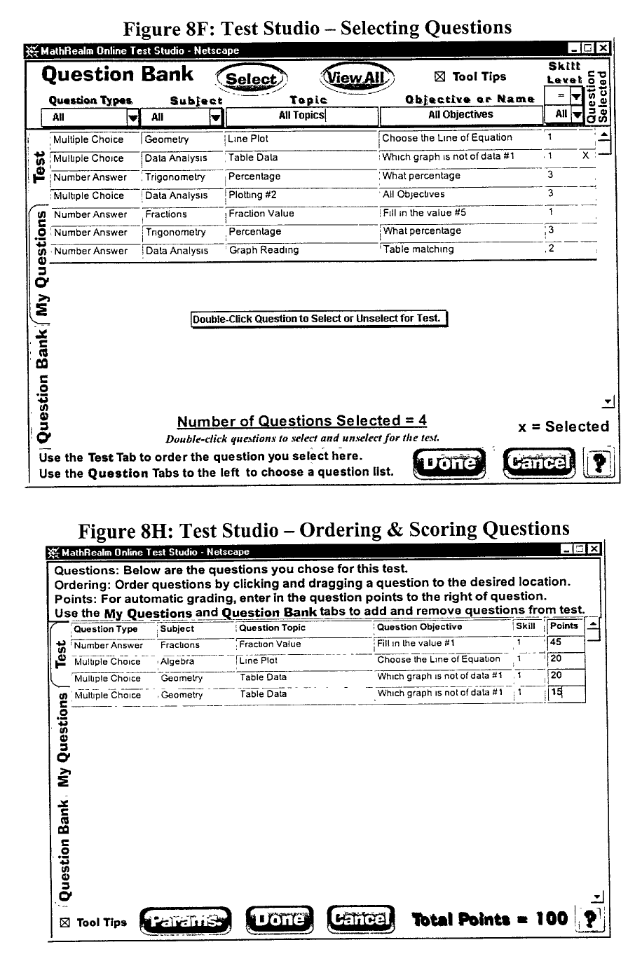

1. Integration of tools to create question content. According to this aspect of the invention, tools are built into the question editor to allow the teacher to conveniently devise and include fraction diagrams, percent diagrams, tables, graphs (circle, bar, line, histogram), plots, and drawings in worksheets and tests. These tools include both graphical tools, such as line-drawing, circle-creation, area-filling and other known functions, e.g., as provided in Microsoft's Paintbrush program, (and as exemplified by the vertical rows of icons shown on the left side of the screen of FIG. 8C, dicussed below) and algorithmic tools, such as tools which generate a graph from an equation provided by the educator. When the educator selects this feature, a dialog box comes up, in which the educator enters the equation and pertinent graph formatting parameters; the program then draws and displays the graph. The educator can then create a set of multiple-choice questions based on the drawing or graph, if desired. By comparison, other online testing systems known to the inventor allow at most the inclusion of text and pictures. More specifically, although prior art online testing systems allow for use of non-textual materials, which could include graphs or charts, the prior art does not allow such materials to be created by the teacher within the program itself; they are at most simply fixed pictorial representations.

2. As noted above, the Test Studio's tests and worksheets are integrated directly into the curriculum management platform as a resource assignment for syllabi.

3. All worksheets and tests are immediately available for inclusion in syllabi. Once a test is included in a class syllabus, students can immediately take the test online. The test is automatically graded and recorded in the platform's tracking system.

Using the Test Studio

There are two major parts to the Worksheet & Test Studio, that is, Working with Questions and Working with Tests. Working with Questions is the question editor and the question management system. Working with Tests is the test and worksheet editor and the test management system. The first step in creating any test or worksheet is to create the questions in the question editor to be included; these questions are then used to create tests and worksheets. Typically the test and worksheet editor is then used to build a test or worksheet by selecting and organizing the questions and assigning each question a point value, thus allowing the automatic grading of the test or worksheet.

FIG. 8, titled Test Studio Operation, shows a number of screens, identified by letter labels and reproduced on separate sheets as FIGS. 8A, 8C, 8D, 8E, 8F, and 8H, and includes arrows labeled B and G, together illustrating a work flow chart for a teacher using the Worksheet & Test Studio. The teacher can move back and forth between Working with Questions and Working with Tests by pressing the buttons with the same names defined on the corresponding management pages; see FIGS. 8A and 8D. FIG. 8 thus exemplifies the flow of creating questions for tests or worksheets. The following paragraphs describe this process in further detail, referring to the letter labels on the FIG. 8 flow chart, and the larger-scale views of the corresponding screens reproduced as FIGS. 8A, 8C, 8D, 8E, 8F, and 8H.

Screen A: Working with Questions (FIG. 8A):

This screen is used by the teacher to manage the questions being created. The teacher can search and organize questions based on the question type, subject, topic or objective key words and skill level of questions, and can access stored questions or questions in the MathRealm Question Bank. (Table 130, as discussed below in connection with FIG. 27.)

Arrow B (extending between FIGS. 8A and 8C):

This arrow indicates that the teacher can use the buttons on the Working with Questions Screen A to create New questions, Duplicate and edit stored or Question Bank questions, or Edit questions, using tools provided on Screen C, discussed below. Thus, the Edit or Duplicate button of Screen A takes the teacher to the Screen C question editor to edit the selected question, while the New button takes the teacher to the question editor with a blank screen where any kind of question can be created.

Screen C. Question Editor (FIG. 8C):

With the question editor of Screen C the teacher can create and edit multiple choice, true/false, numeric or word questions. There are tools to insert and format text, fraction and percent diagrams, plots, tables, and circle, bar, line and histogram graphs. As indicated above, the educator is provided with a wide range of tools for creating a variety of types of questions. Original drawings and diagrams can be created with the graphic tools indicated by the rows of icons on the left side of FIG. 8C, algorithmic tools can be used to create a graph based on an equation input by the educator, and text can be added for creating questions. The student is also provided with an answer space; when the student later accesses the syllabus, the assignment, and ultimately the question, and inputs an answer, the answer is automatically tracked by the platform and becomes part of the student's grade.

Screen D. Managing Tests (FIG. 8D):

This is the screen used to manage the tests and worksheets created. Using this screen, the teacher can access and edit tests or worksheets he or she has created, or ones in the MathRealm Test Bank. New tests or worksheets are created, or existing tests or worksheets edited or duplicated using this screen. As indicated above, when the student later accesses the syllabus, the assignment, and ultimately the question, and inputs an answer, the answer is automatically tracked by the platform and becomes part of the student's grade.

Screen E. Test or Worksheet Parameters (FIG. 8E):

This screen is used to edit the parameters of the tests or worksheets. The Test Name and Subject are the parameters used to include the test or worksheet into a class syllabus for the student(s) use. The teacher presses the Questions button to add, delete and organize the questions of the test or worksheet.

Screen F. Select Questions (FIG. 8F):

This screen is used to select questions from an existing set stored as part of the proprietor's database, for inclusion in a test or worksheet. Questions are selected simply by double clicking on the questions that are displayed. Questions, including both teacher-created questions and questions in the MathRealm Question Table (again, see table 130 of FIG. 27), can be searched for based on the question type, subject, topic or objective key words and skill level of questions.

Arrow G. (extending between FIGS. 8F and 8H):

This arrow indicates that the teacher can switch between Selecting Questions (FIG. 8F) and Ordering & Scoring Questions (FIG. 8H), using the tabs provided on the left side of the screens, making it easy to add groups of questions and order them.

Screen H. Ordering & Scoring Questions (FIG. 8H):

This screen is used to drag-and-drop questions to order them for the test or worksheet. The points for each question are entered in the left column of the question table, and are automatically totaled. This is the basis for the automatic grading provided according to the invention. The teacher presses the Done button when finished editing, and the completed test or worksheet is then stored in the proprietor's database (see Table 122 of FIG. 27), for subsequent accessing and use by the corresponding students.

Once a test or worksheet is created by the educator it can easily be inserted into a class syllabus by selecting it, using the assigned Subject and Test Name. The tests and worksheets become automatically available in the syllabus editor.

Using Tests or Worksheets in Syllabi

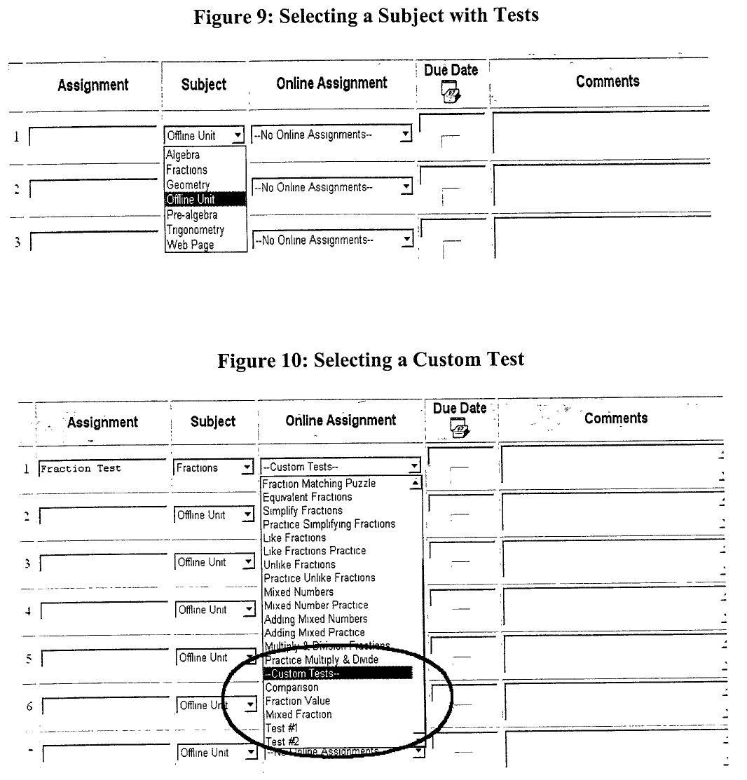

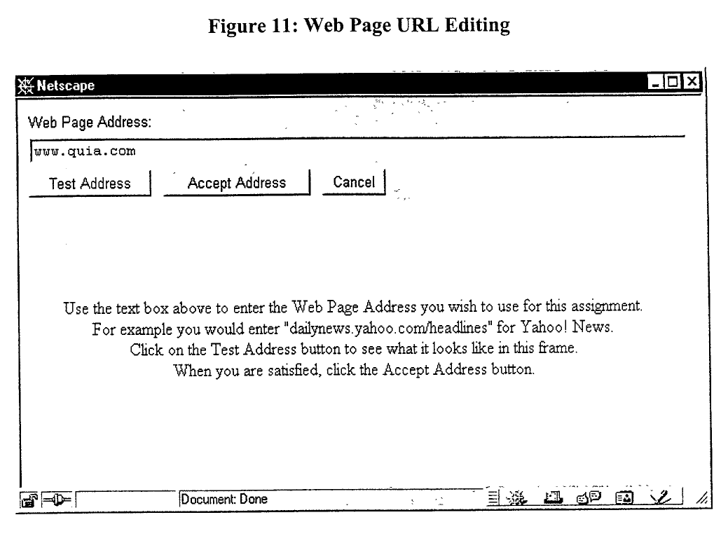

According to another important aspect of the invention, a teacher can include the tests or worksheets previously created in a syllabus being edited or created. FIGS. 9 and 10 show the pertinent screens. For example, a previously-created test is inserted into a syllabus by: 1) selecting the Subject of the test in the drop-down menu of a syllabus editing screen (see FIG. 9); 2) selecting the Test Name of test in the Online Assignment drop-down menu, listed after the “--Custom Test--” line (see FIG. 10). This will insert the test into the syllabus, which is then launched by a student clicking on the syllabus icon of the test or worksheet.

Custom Type: Slide Show

As mentioned above in connection with FIG. 6, one of the Custom Types is the Slide Show, which, as the name suggests, comprises a sequence of screens. Custom Slides are created by the user in the same manner as a Custom Test except the user makes one screen after another, in the same manner as done using common presentation programs, such as Microsoft's Power Point. The same tools available in the Test Studio (see FIG. 8) are available for creating the slide shows. All custom slide shows developed by a user are stored on the proprietor's database and are available to the creator, by password, at any Internet connected computer or workstation, for entry into a syllabus and subsequent access and use by students, or for use in other syllabi. The user provides a subject and a name for the slide show just as in connection with Test Studio tests or worksheets. When editing or creating a syllabus the user selects a subject for which they have created a slide show. The user can then include the slide show in a syllabus by selecting its name, which is listed after the “--Slide Show--” line, in the Online Assignment drop-down menu.

Custom Type: Web Pages Via URLs

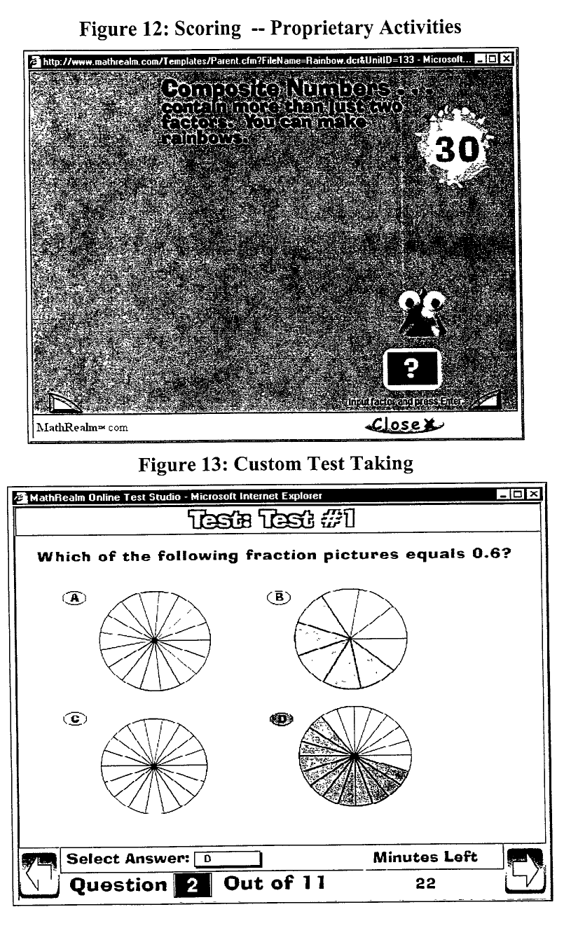

As also mentioned above, another of the Custom Types of syllabus entries is a Web page, provided to the student for immediate access by clicking on the URL of the page of interest. FIG. 11 shows a window provided for convenient entry of such Web pages in the syllabi for the teacher's use. This window pops up when Web Page option is selected in the Subject drop down menu of FIG. 9, that is, when editing or creating a syllabus. In this window (FIG. 11) a user enters the full URL of the Web page to include in the syllabus (ie., www.mathrealm/algebra/outline.htm) in the top form field. To test for a valid address the user presses the “Test Address” button and the entered Web page appears in the lower part of the window. When the user is satisfied with the URL entered, he or she then presses the “Accept Address” button to accept the entered URL, and it is then included in the syllabus. See FIG. 11.

Platform Student Usage Tracking

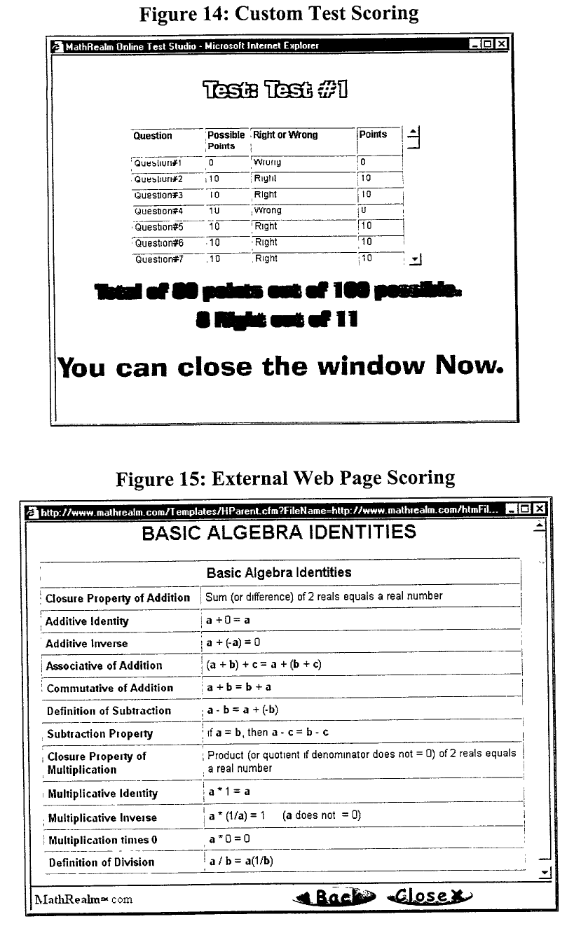

Grading tests and assignments is undoubtedly one of the most tedious of the teacher's duties. To reduce this burden, the Class and Curriculum Management Platform of the invention tracks the use of all online activities of each student in a class. When activities (lessons, tests, practice, web pages, etc.) are launched from the student's syllabus page they are opened in a browser window, as noted above. Each activity is scored in two ways: 1) the number of visits to that activity by each student are counted; and 2) a numeric score is given to each student responsive to their activities. The numeric score may be recorded as a percentage, where appropriate, depending on the type of activity. FIGS. 12 to 15 show screens illustrative of the approaches to scoring of student responses to assignments made possible according to this aspect of the invention.

Proprietary lessons and practice are scored when the student finishes. FIG. 12 shows a single question that might typically form part of a test or assignment; after the student provides the answer that is prompted, a further question screen is displayed, and so on. Typically, the student's responses to the lesson of which FIG. 12 forms one screen will only be scored when the student finishes the lesson. The lesson sends the score to the platform when it is completed. For a correctly completed lesson the scoring would be visits=1 and score=100; that is, in this embodiment, the score of 100 for a lesson indicates the student correctly completed 100 percent of the lesson. When a student visits the same lesson more than once, the platform keeps track of the total number of times a student completes this lesson. This facility can be used to track the student's participation overall. Together with the possible points the educator assigned to that lesson when they assigned the syllabus to that student, the participation score is used to determine the student's final score for that activity. Proprietary practice activities are scored similarly, but the score is the actual percentage of the attempted problems that were answered correctly.

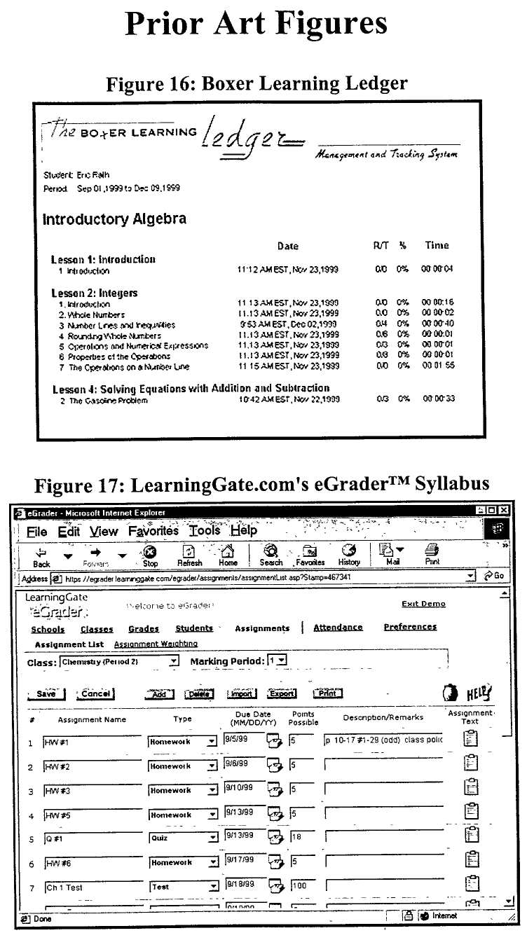

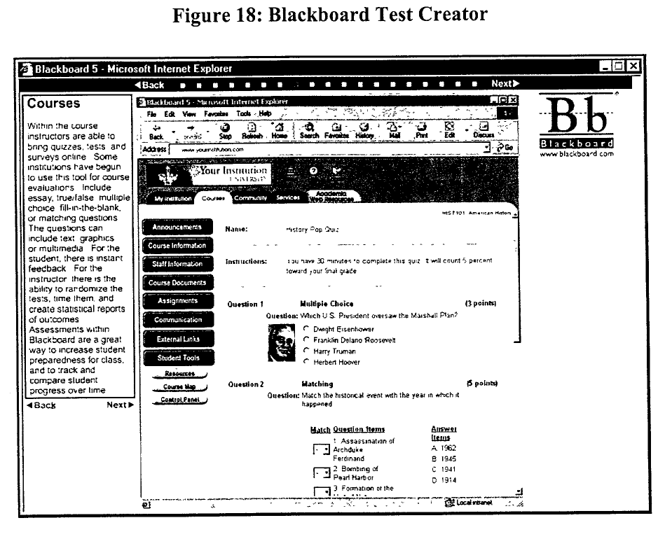

FIG. 13 is a screen illustrating one problem of a typical Custom Test. Of course, the same problem could be included as part of a stored test or assignment. As indicated, the student sees a single problem on screen at a time, and enters his or her answer in the Select Answer box. FIG. 14 is a screen showing the score the student received for a typical test. This score is transmitted to the platform as described above, and the score is recorded.

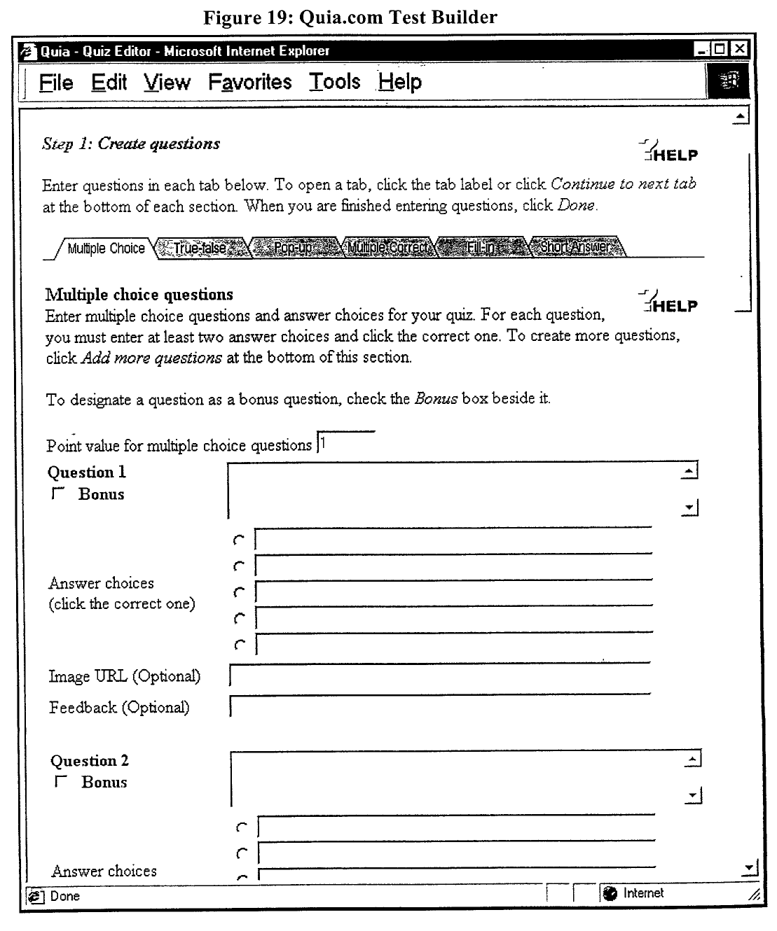

FIG. 15 is an example of an external custom web page the educator included in the syllabus. Since there is no responsive activity required of the student for this activity, the student would receive a score of visits=1 and score=100 simply for accessing this page.

Comparison with Prior Art

Having now described the functions of the Class and Curriculum Management Platform according to the invention in some detail, it is possible to draw instructive comparison with the pertinent prior art known to the inventor.

Class Administration Software

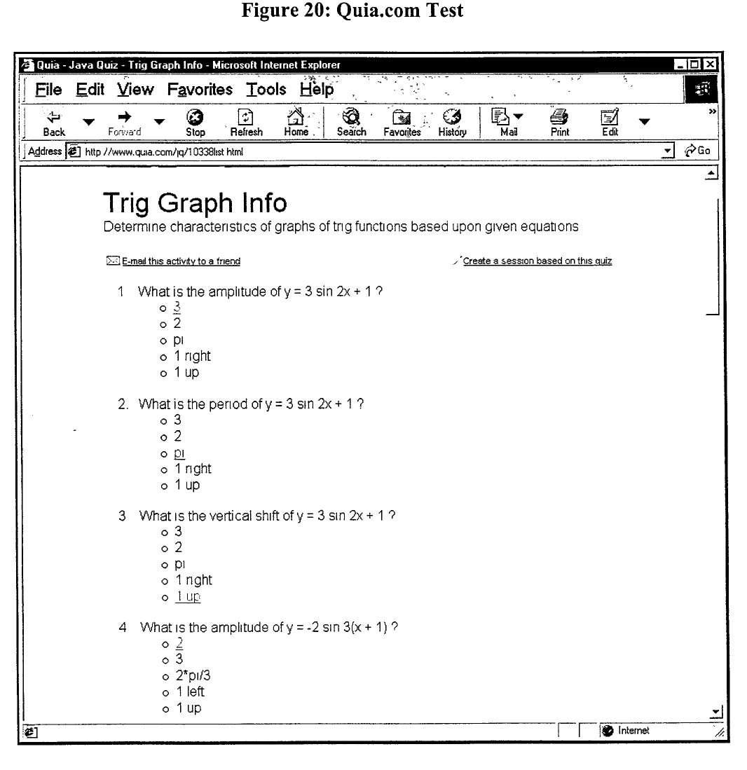

Most online and computer based curriculum management platforms are simply designed to provide automation of clerical functions, e.g., to track and manage students in static or non-changing courses. This is the case with non-web based courseware and online courseware such as BoxerMath.com's Ledger. A sample screen shot of this program is provided as FIG. 16; it is apparent that this is simply an online grade book.

The traditional method for educators to develop a class syllabus is to use pen and paper or a word processor to outline assignments. LearningGate.com's eGrader is a web-based form for creating an assignment list. An example screen from this program is provided as FIG. 17. It will be apparent that this tool is simply a form based storage method and does not in any way link to, launch, or track any type of online learning resource.

Online Test Studio Prior Art

Tools provided by Blackboard.com and WebCT.com are designed to administer courses and can provide links to educator developed course web pages. See FIG. 18, Blackboard.com's Test Creator, showing an on-line pop quiz, presumably providing automatic grading in response to the student's responses, and FIG. 19, Quia.com's Test Builder, showing an HTML form to be used by a teacher to build a test by manually entering the questions and possible multiple-choice answers. MicroTest III from Jackson Software is generally similar. As indicated, the Quia.com form allows inclusion of a URL for the student to access; however, unlike the present invention, wherein all such activites of the student are tracked and used to generate a report, the Quia.com form provides no such tracking capability. The teacher's completion of these forms generates additional form pages that deliver the test; see FIG. 20, an example of the Quia.com test itself Note that there is no suggestion here of selecting prior test materials from a database. That is, the Blackboard.com and Quia.com tests are not linked to a syllabus based management system. Their users are obliged to create individual tests, and cannot select questions that can be reused in many tests.

More particularly, these systems do not provide sophisticated tools for creating question content. For example, the educators are apparently limited to verbal questions only, which is highly restrictive. Note that the Quia.com test in FIG. 20 is entitled “Trig Graph Info”, but that no graphs are shown, which is self-evidently an inferior way of testing the subject.

Another category of stand alone computer test tools involves the generation of random problem worksheets from templates. Examples of this type include Vision Technologies Math Companion I & II, or Cendent's Test Creator series, and there are many others. This class of product is designed to create print based tests, which the educator is required to grade by hand. All such products known to the inventor are limited to text entry and picture insertion.

By comparison, using the MathRealm Test Studio provided according to the invention, the teacher has all the tools needed to create question objects and manage the questions and tests which are linked into the syllabus platform. The unique question objects include fraction diagrams, percent diagrams, tables, graphs (circle, bar, line, and histogram), plots, and drawings. Furthermore, the teacher can use all or part of any of a number of questions or tests stored on the proprietor's database, can add individual questions as needed, and can then store these for future use. See FIGS. 8A to 8H.

The MathRealm Whiteboard

MathRealm's Whiteboard is a collaborative workspace where multiple “session users” can include, share and discuss text, equations, fractions, percents, tables, graphs, plots and drawings. It is designed for sharing ideas and working on problems with others over the Web. Accordingly, a teacher at a work space can pose a question, for example, involving the drawing of a graph, and receive answers drawn by students in several different locations around the world, in real time. Moreover, the students can see one another's work, as well. Accordingly, a very close approximation is provided to the ideal small classroom setting, where each student has an opportunity to participate and interact.

MathRealm's whiteboard is unique in that the teacher(s) and student(s) can share diagrams, tables, graphs, equations and plots as well as drawing and text. Each “local” user can view a “remote user's” whiteboard user's work while at the same time doing his or her own work on screen. The remote user and other users can be viewing the local user's work at the same time as well. There are also discussion tools built-in so that users can discuss their work—individually or as a group.

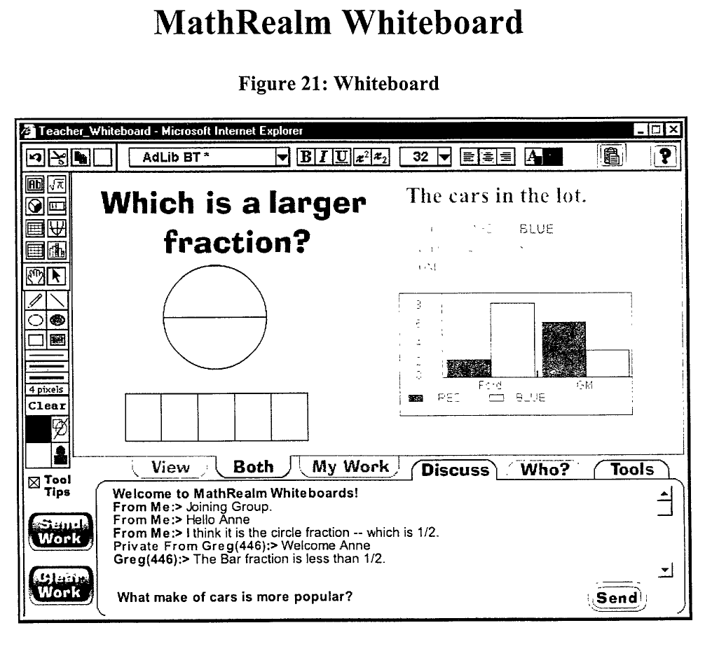

FIG. 21 is a sample Whiteboard screen according to the invention. The upper portion of the screen shows the work of two users, corresponding to the local user having selected the ‘Both’ tab, as indicated. The work of the local user is shown on the left, and the work on the right is that of a remote user. The local user can identify the remote user whose work to view using the ‘View’ tab, and can see only his or her own work by selecting the ‘My Work’ tab. The users draw in their respective fields using the graphical tools indicated by the row of icons, and use the text editor to type “instant messages” appearing in the dialogue box at the bottom of the screen.

As illustrated in FIG. 21, the remote user's work is shown slightly faded. This is done according to the invention to help the viewer in remembering the source of the work being displayed. The degree of fading is controllable, as discussed below.

Typically the teacher in an on-line session using the Whiteboard will select the remote user whose work he or she desires to view, so that that student's work is effectively viewed in the background, and controls the degree to which this work “fades” into the background. As further illustrated, the lower portion of the screen includes several lines of text, which, as will be apparent, allow for real time or “instant messaging” communication between several session users, not necessarily only those whose work is being displayed in the upper portion of the screen.

The Whiteboard according to the invention includes several novel and useful features, as follows:

1. As indicated by the icons on the left side of the display of FIG. 21, the Whiteboard includes built-in graphic and algorithmic tools for creating and editing fraction diagrams, percent diagrams, tables, graphs (circle, bar, line, histogram, etc.) and plots of equations. When these objects are created, e.g., by a teacher, they automatically appear on the Whiteboards of all session users (e.g., students) who have selected the teacher's work to view. Known prior art whiteboard systems only have text and drawing capabilities. That is, according to the invention, the educator has the ability to input an equation, and an algorithmic tool then generates a graph seen by all of the remote users.

2. Moreover, according to the invention an existing whiteboard display can be edited, and the remote users see this as it is being done; known prior art systems require an existing drawing to be erased before changes can be made, although the creation of a new drawing itself can be viewed in real time. That is, all objects created by a user (in 1 above) can be edited by that user and these edits are automatically reflected in the corresponding views seen by all remote users. In other whiteboard systems one is obliged to erase and start over in order to make changes.

3. The Whiteboard of the invention allows multiple users to view one specific user's work, for example, a number of students can simultaneously see the contents of the teacher's whiteboard. Conversely, one user (such as an instructor) can easily look at the work of all the session users; typically this would be done one student at a time. Further, any user can elect to view any other user's work at any time and discuss it. Thus, in addition to the standard one-to-one communications provided by known whiteboard systems, that of the invention allows:

Many-to-one communications

One-to-many communication.

4. The method that allows this flexible and powerful viewing mechanism is very novel.

Fading view display of the selected remote user being viewed.

Tab based view options: view remote user's work only, view local user's work only, or view both the remote user's and local user's work simultaneously.

Whiteboard Feature Operation

When a user launches the MathRealm Whiteboard from the Web site he or she is given the option to join a group of users, for example, to join a specific class or general subject groups such as fractions, geometry, algebra, etc.

Selecting Who to View

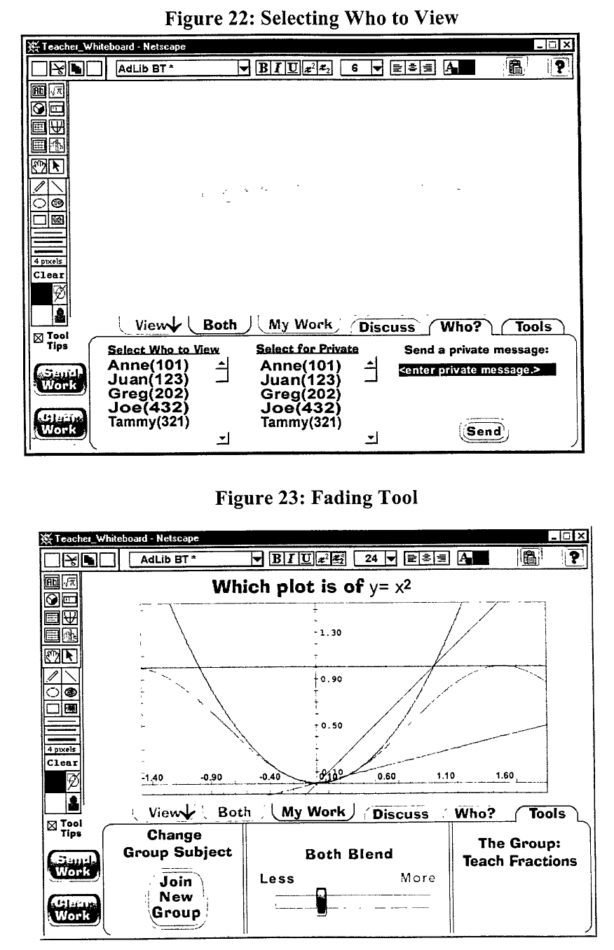

After joining a group, the “local user” sees the screen in FIG. 22. As will be apparent, the bottom half of the local user's screen provides, on the left, a list of active session users, allowing the local user to choose whose work to view. There are two lists of people belonging to the group. Simply clicking on the user name of interest selects the remote user whose work is to be viewed. To change the remote user whose work is viewed, the local user simply clicks on the name of a different remote user. As shown, the list of individuals under the ‘Select Who to View’ heading includes their first name and a number, so as to help uniquely identify them in case more than one user of a group has the same first name.

View, Both, and My Work Tabs

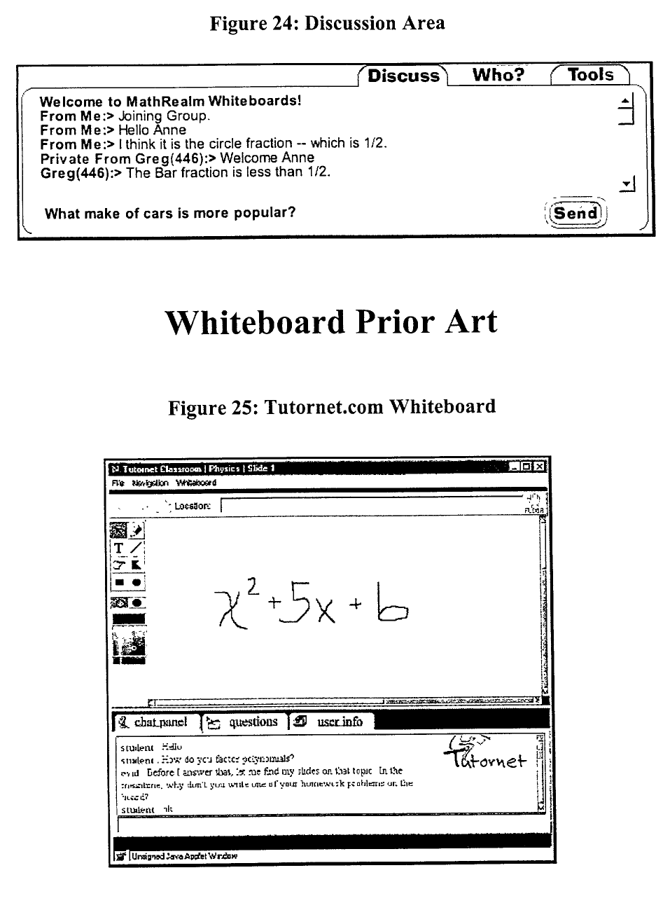

Having selected a remote user as above, all of the work done by the selected remote user will be seen on the screen. To view only that user's work, and not the local user's work, the local user can press the ‘View’ tab below the work area. To view both the local user's work and a selected remote user's work, the local user presses the ‘Both’ tab. The remote user's work will appear faded and in the background. The local user can adjust the amount of fading by accessing that control, found under the ‘Tools’ tab at the bottom right of the work area. Fading is discussed further in connection with FIG. 23. Finally, the local user can press the ‘My Work’ tab to view only his or her own work, as illustrated by FIG. 23. The local user can insert and edit objects on the work area with either the ‘Both’ or ‘My Work’ tabs selected.

As noted, in order to view only the work of the selected remote user, and not his or her own work, the local user can press the ‘View’ tab below the work area. When the ‘View’ tab is pressed, all the edit tools will be blocked out and all of the local user's work will become invisible to him or her, although other remote users who select the local user's work to view will still see it (i.e., the local user becomes that remote user's selected remote user). The work of each user is continually updated, even when invisible on a particular user's screen; this allows, for example, each of a group of students to work on their own whiteboards simultaneously, and the teacher to view the work of each in turn. As indicated, the local user can select either the ‘Both’ or the ‘My Work’ tabs to see his or her own work again.

As noted, when the local user views both his or her own work and a selected remote user's work, the selected remote user's work will appear faded and in the background. The amount of fading can be adjusted by accessing a control found under the ‘Tools’ tab at the bottom right of the work area, as illustrated in FIG. 23. The advantage of this controllable fading option is that it allows the local user to work on the screen while still viewing the selected user's work. For example, this lets a teacher make comments, circle items on the screen, or add his or her own work, which the other user can view by selecting the teacher as remote user. This allows teacher and student to collaborate on a problem. Local users can even work with multiple users this way; as noted, to change the selection of the remote user whose work is being viewed, the local user simply selects a new remote user under the ‘Select Who to View?’ tab.

Tools

As indicated, the ‘Tools’ tab (see FIG. 23, which displays in its bottom portion several sub-portions of the total screen that are visible when the “tools” tab is selected, as indicated) allows the user to adjust the level to which the work of a selected user being viewed is faded, by adjusting the “Both Blend” control shown. The selected remote user's work will be viewed in the background and the blend level will determine how bold or faded this work is seen by the local user when the ‘Both’ tab is selected. Meanwhile, the respective local users can still make changes on the object displayed on their respective whiteboards; the changed objects are then displayed on the remote user's whiteboard when selected.

Private Messages; Discussion Group

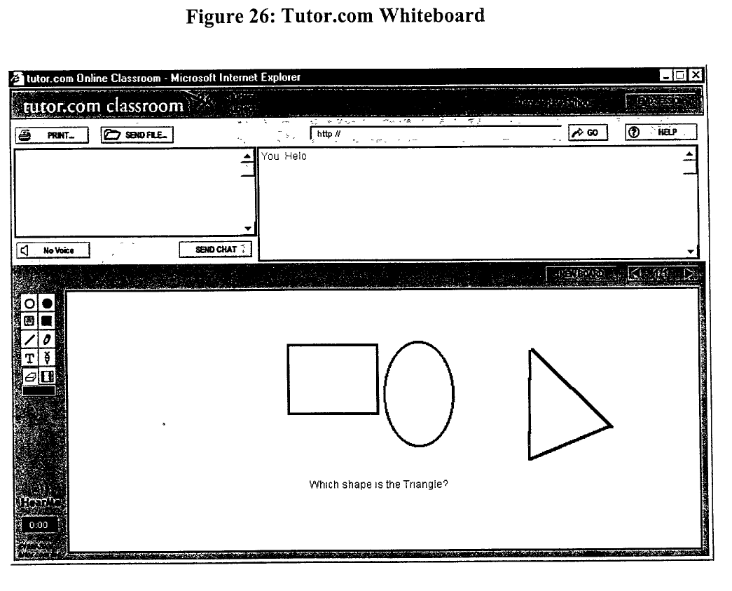

FIG. 24 shows a view of the lower portion of FIG. 21, and illustrates the Discussion area, which can be accessed by pressing the “Discuss” button on the screens of FIGS. 21 to 24. This facility can be used by a student, for example to answer a question posed by the teacher with respect to a graph displayed on the whiteboard, as in FIG. 23. As indicated, the Discussion area provides “instant messaging” capabilities, whereby all of the session users can communicate with one another. As shown on FIG. 22, the local user is also given a list of session users, under the heading “Select for Private”. By selecting one of these, a private message can be sent, by typing it in the space provided on the lower right portion of the screen shown in FIG. 22. The ‘Select Who to View’ list can also be accessed under the ‘Who?’ tab, in the middle of FIG. 24. This list is similarly provided to allow a local user to select a member to whom the local user wishes to send a private message. The local user selects the remote user by clicking on their name, types the private message in the text field to the right, and presses send or Enter. The message is only sent to the local user (i.e., it is displayed on the discussion screen, as shown) and the selected user. The message recipient is informed that the message is private. See FIG. 24 for an example.

Comparably, the ‘Discuss’ tab in FIG. 24 allows users to discuss their work with all members of the session group. The local user can type a message in a text field (which may be delimited by color, and appear as indicated at the bottom of the FIG. 24 screen) and press Send or Enter to send it to all members of the group. In this embodiment, all messages appear in a different area of the screen, in this embodiment above the message being composed. The user's names may be color-coded to tell the local user who the messages are from, and whether any of the messages are private.

Whiteboard Prior Art

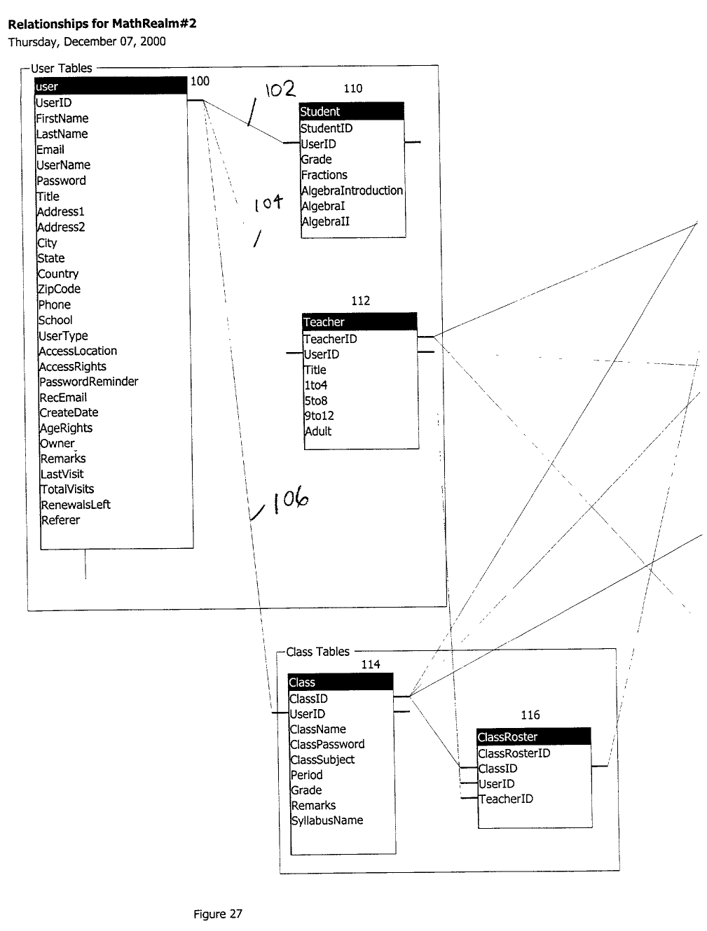

Prior art in whiteboard technology in the online teaching area is exemplified by two very similar online services, Tutornet.com and Tutor.com., respectively. FIGS. 25 and 26 are screen shots of Tutornet.com's and Tutor.com's whiteboard systems Both of these Web based tutoring services allow one-to-one communication on a whiteboard, and have tools for drawing and text placement. They do not have the capability of many-to-one nor one-to-many communications, and neither allows the sharing of fraction, percent, tables, graphs (circle, line, bar, histograms, etc.) or plots of equations, both as provided according to the invention. Furthermore, neither of these whiteboard platforms allows the editing of items after placement on the screen; the user must erase and redo the initial work to make changes.

Other examples of whiteboard systems include the example provided in Macromedia's Director Development Studio—a many-to-many whiteboard. This system allows a group of people to share one “canvas” over the Web. When any individual in the group draws on the “canvas” all the other users of the whiteboard see the drawing along with all the other user's drawings simultaneously. This method provides no user control and is of little value for communicating ideas in a one-to-many or many-to-one or one-to-one situation. The situation provided by these programs is roughly equivalent to having a classroom of simultaneously shouting students; the teacher cannot focus on one student at a time. By comparison, according to the present invention, the students can all work on their whiteboards simultaneously, and the teacher can access each in turn.

Database Structure

FIG. 27 shows an overview of the organization of the proprietor's database in one possible implementation of the invention; the invention is not to be limited to this implementation. The diagram of FIG. 27 indicates that the exemplary database is organized as 12 separate tables, each collecting various data of interest with respect to a number of like entities, and illustrates some of the common entries provided as to plural tables, so as to indicate the “navigational” linkages provided by the platform according to the invention. Those of skill in the art will understand from FIG. 27 the detailed steps required to create and maintain the database thus defined; any of a number of database programs are suitable for use in implementation of this aspect of the invention.

As illustrated in FIG. 27, the database required to be maintained by the proprietor of the platform in one exemplary embodiment may comprise 12 total tables, organized into four groups, labeled as User Tables, Class Tables, Syllabus Tables, and Custom Test Tables. Each table comprises a collection of entries, and each entry includes the items of information listed in each table. Although this grouping of the tables, the titles of the tables shown, the relations between the items in the tables indicated by the connecting lines shown, and the individual items collected for each of the entries in each of the tables do not limit the invention, these will be of value to one of skill in the art in understanding this aspect of the detailed implementation of the invention.

Thus, the entries in a first “User” table 100 each pertain to one of the users of the platform, as indicated by the legend “User” in reverse video; accordingly, as will be understood by one of skill in the art, some or all of the items listed under “User” are collected and stored for each entry, corresponding to each authorized user. As indicated by the names of the listed items, each user is assigned a User ID, and is prompted to enter the identification and address items listed, and to choose a password. The platform can collect data concerning, for example, each user's use of the platform, as suggested by the “LastVisit” and “TotalVisits” items, as well as concerning the user's ability to access and use the platform, as indicated by the “AccessLocation”, “AccessRights”, and “RenewalsLeft” items.

As indicated by the connecting lines 102, 104, and 106, the UserID can be considered the connecting link whereby the user is entered into one or more of the Student table 110, the Teacher table 112 and/or the Class table 114. Each of these tables includes further identification information, e.g., StudentID, TeacherID, and ClassID, as indicated; similarly, the ClassID, UserID, and TeacherID information can be used to create a ClassRoster table 116, as indicated.

The functions of the tables shown in FIG. 27 will be apparent to those of skill in the art. For example, it will be apparent that the User table 100 includes entries for each of the users entitled (typically by prearrangement with the proprietor) to use the platform of the invention; the Student table 110 includes entries for all of the Users who are Students, and the Teacher table 112 entries for all of the Users who are Educators. Similarly, the Class table 114 includes entries for the class to which the user belongs, and the syllabus assigned to the class, and the Class Roster table 116 links student users to the class or Class Table.

As discussed above, the syllabi provided according to the invention are critical to achievement of the goals thereof As noted, a “syllabus” according to the invention is a data structure, created in the first instance by an educator, and typically including a list of assignments, sets of problems, links to Web pages for reading, and the like. After creation of a list of student(s) intended to use a given syllabus, the syllabus is stored on the database. The corresponding students then access their assigned syllabi and carry out the assigned tasks online, thus performing the learning activities. The student's progress in completing lessons, tests, activities, etc. of an assigned syllabus results in the generation of reports. Educators can thus develop and distribute an individualized (or customized) syllabus for a class or single student.

FIG. 27 accordingly provides in Syllabus table 118 a set of entries each pertaining to a single syllabus. Each unit of a syllabus has a separate entry in the Syllabus table. As indicated, the syllabi are organized by SectionID (“SyllabusID” might be a more informative name for this item), as the assignments may be organized as sections, by ClassID, indicating the class to which the syllabus is assigned, and by Teacher ID.

Table 120 is the SectionUnit table, and as indicated by the list of items stored as part of each entry, each entry in the SectionUnit table includes in addition to the pertinent identification data (SectionUnitID, SectionID, Class ID, and UnitID), the CustomTestID, the Assignments, their Type and Due Date, as well as any Comments and the Possible Points to be earned as to each. Thus, each entry in the SectionUnit table is an individual assignment of a syllabus section.

As discussed above, the Assignments are organized into Units; correspondingly, the basic component of the SectionUnit table 120 is the UnitID, which provides a link to the Assignments table 126. As indicated at 126, the entries in the corresponding Assignments table 126 include FileName and FileType, thus indicating that the entries in the Assignments table 126 include specification of the type of the entries in the syllabus, such as whether they are lessons or practice or Custom Types such as Custom Tests or URLs. Custom Types are designated by specific UnitID numbers in the Assignments table 126.

As mentioned above, according one important aspect of the invention, the educators are enabled to define Custom Tests as may be desirable. The entries in Custom Test table 122 are the tests themselves. This table relates the specific tests to a specific educator and contains a list of the test questions and their assigned scores. As indicated the Custom Test entries are organized by Skill, Topic, Objective, Time Limit and other criteria useful to the educator in later reusing the Custom Tests.

Table 124 and 128 are the scoring tables. Syllabus table 124 provides a tracking mechanism for every assignment in a syllabus and counts the number of times an assignment is completed and the scores earned on the assignment. The Custom Score table 128 collects information referring to each student's score on every question of a Custom Test.

Finally, the entries in Question table 130 are the actual questions available for selection by educators in building a custom test. As indicated, the questions are organized by Type, Subject, Skill, Topic and Objective; thus, for example, if the teacher wants to create a custom test of geometric concepts at the seventh-grade level employing multiple-choice, graph-based questions, he or she enters those criteria (using the On-line Test Studio of FIGS. 8A and 8F), and the proprietor's database responds with an appropriate selection of questions.

Having now discussed the platform implementing one embodiment of the invention in detail, and described the manner in which the platform proprietor's database can be organized to cooperate therewith, those of skill in the art will appreciate that the specific attributes of the invention listed above are indeed achieved thereby.

Specifically, as noted above, it was desired to provide database-driven customization of syllabi; this is accomplished as described in connection with FIG. 27.

The syllabi are customizable at the assignment and unit level for a class or individual students; by assigning custom tests to a given class, for example, the syllabus is thus customized, and by assigning a test to a single student, the syllabus is customized for that student.

Users can use a wizard to generate a class syllabus from pre-defined templates, as described in connection with FIG. 2.

By allowing URLs to be employed in the syllabi as assigments, the syllabi link to and launch online content directly.

The platform includes a proprietary database table of assignments (lessons, tools, tests, practice, learning games, etc.), that is the Assignments table 126; these, as well as the Custom Tests table 122, and external web pages are used in building customized syllabi. These assignments and web pages are accessed by the syllabus editing tools for educators as in FIG. 5; students are provided similar access, but of course without editing tools.

As discussed in connection with FIG. 27, custom tests and worksheets developed by a user are automatically included in the Class and Curriculum Management Platform resources, and can also be included in custom syllabi. As indicated by the Score table 128 of FIG. 27, the system can track details of tests results, overall score, and the correctness of each question.

The platform provides the ability for an educator to include any external web resource by inserting its URL in a syllabus. User can launch the URL directly from the syllabus as an assignment in the syllabus.

As indicated by table 124 of FIG. 27, the system can track student usage of any kind of online resource and generate reports.

Finally, it is anticipated that presentations, e.g., slide shows as created with Microsoft's PowerPoint or the like can likewise be integrated into the syllabi, using the mecahinsm described above in connection with the Custom Tests. A further Table will be added to the database, listing the slide shows and providing a convenient means for their insertion into future syllabi.

While a preferred embodiment of and a number of possible modifications to the invention have been disclosed in detail, the invention is not to be limited thereby, but only by the following claims.

What is claimed is:

1. A system for assisting educators in developing syllabi for online education, said syllabi comprising stored assignments, and for enabling online access to said syllabi by students, comprising:
a software program defining a platform, said platform comprising a series of interrelated screens defining spaces for an educator to provide specific information and to select from options controlling further operation of said platform; and
a database maintained by the proprietor of said platform, and accessible online by said educators and said students, comprising a number of tables for storing syllabi, lists of students, lists of educators, and class lists associating the students and educators with selected syllabi;
said software program comprising a first version to be employed by said educators for accessing and using said platform to define and store syllabi, and a second version to be employed by said students to access said syllabi and carry out the stored assignments comprised thereby;
wherein said series of interrelated screens include at least:
a syllabus creation screen, whereby an educator is provided with tools enabling selection of a syllabus from a collection of syllabi stored as part of said database, creation of a syllabus using a stored template, or creation of a syllabus not based on a template;
at least one syllabus editing screen, whereby an educator is provided with tools enabling editing of a syllabus; and
a test studio, comprising screens providing an educator with tools enabling creation and editing of tests, said tools enabling the creation, duplication and editing of questions, and creation of tests by selection of questions and assignments of score values.

2. The system of claim 1, wherein said series of interrelated screens further comprise a class management screen, whereby a class of one or more students may be associated with one or more specific syllabi.

3. The system of claim 1, wherein said database comprising a number of tables for storing syllabi, lists of students, lists of educators, and class lists associating the students and educators with selected syllabi comprises a set of user tables, listing the persons entitled to access one or both of the versions of said software, a set of syllabus tables, listing the syllabi available and the assignments comprising the syllabi, a set of class tables, listing the students assigned to each class, and a set of custom test tables, listing tests and questions comprised by said tests.

4. The system of claim 1, wherein the first and second versions of said software program to be employed by said educators and students respectively each allow a local user to select a screen defining a whiteboard area and a selection of graphic tools, whereby the local user can use the graphic tools to define visible material appearing on said whiteboard area, and wherein said local user can display the whiteboard areas of at least one remote user simultaneously with his or her own, for comparison of their respective visible materials.

5. The system of claim 4, wherein the local user is provided with the option to select his or her own whiteboard area, a remote user's whiteboard area, or both for display, and wherein both the local user's and remote user's whiteboard areas are updated whether not they are being displayed.

6. The system of claim 5, wherein said screen defining a whiteboard area provides means for selection of the whiteboard area to be displayed.

7. The system of claim 4, wherein each of said users is further provided with a fading tool for controlling the relative intensity of their own and said at least one remote user's visible materials as displayed on their respective screens.

8. The system of claim 1, wherein said series of interrelated screens includes a screen enabling the educator to provide a universal resource locator (URL) address of a Web page to be included in an assignment.

9. The system of claim 8, wherein said screen enabling the educator to provide a universal resource locator (URL) address of a Web page to be included in an assignment allows the educator to input a URL address, cause the URL to be transmitted by way of a Web browser to verify the correctness of the URL address, and, if correct, to incorporate the URL address into an assignment.

10. The system of claim 1, wherein said platform is defined by a software program running under a predetermined Web browser, and said series of interrelated screens includes a screen enabling the educator to define a new type of assignment by specifying a new type of file capable of being read by said browser, and incorporating a file of said new type in one or more assignments.

11. The system of claim 1, wherein said platform automatically tracks all access by students to assignments, and records scores on all assignments provided with scorable responses.
